(19) United States
(12) Patent Application Publication
(10) Pub. No.: US 2015/0229350 A1
(43) Pub. Date: Aug. 13, 2015

(54) BROADCASTING TRANSMISSION APPARATUS AND METHOD THEREOF FOR SIMULCAST BROADCASTING

(71) Applicant: ELECTRONICS AND TELECOMMUNICATIONS RESEARCH INSTITUTE, Daejeon (KR)

(72) Inventors: Young Jo BANG, Daejeon (KR); Youn Ok PARK, Daejeon (KR)

(73) Assignee: ELECTRONICS AND TELECOMMUNICATIONS RESEARCH INSTITUTE, Daejeon (KR)

(21) Appl. No.: 14/618,180

(22) Filed: Feb. 10, 2015

(30) Foreign Application Priority Data
Feb. 12, 2014 (KR) 10-2014-0016143

(51) Int. Cl. H04B 1/7073; H04W 36/00; H04L 27/26

(52) U.S. Cl. CPC H04B 1/7073; H04L 27/2628; H04L 27/2655; H04W 36/0005

(57) ABSTRACT

Disclosed is a transmitter installed in a base station included in a wireless communication system for acquiring synchronization including: an IFFT unit configured to perform IFFT with respect to a QAM signal into which a pilot signal is inserted to generate an OFDM signal; a direct sequence spectrum spread signal generator configured to phase shift keying (PSK)-modulate a unique pseudonoise (PN) sequence specifying the base station to generate a direct sequence spectrum spread signal synchronized with the OFDM signal; and an RF transmitter configured to couple the generated OFDM signal and the direct sequence spectrum spread signal synchronized with the OFDM signal, transform the coupled signal into an RF signal, and transmit the signal transformed into the RF signal through an antenna.

### CROSS-REFERENCE TO RELATED APPLICATIONS

This application claims priority to and the benefit of Korean Patent Application No. 10-2014-0016143 filed in the Korean Intellectual Property Office on Feb. 12, 2014, the entire contents of which are incorporated herein by reference.

### TECHNICAL FIELD

The present invention relates to a wireless communication system for acquiring synchronization and a method for controlling the same, and more particularly, to a wireless communication system for acquiring synchronization and a method for controlling the same based on a direct sequence spectrum spread signal (DSSSS) in an orthogonal frequency division multiplexing (OFDM) type wireless communication system.

### BACKGROUND ART

An orthogonal frequency division multiplexing (OFDM) type wireless communication system has a structure in which preamble data are assigned to OFDM symbols for synchronization in order to be transmitted together with transmission frame data.

Insertion of the preamble data symbol in the OFDM type acts as a factor of decreasing frequency efficiency of the entire system.

### SUMMARY OF THE INVENTION

The present invention has been made in an effort to provide a wireless communication system for synchronization and a method for controlling the same in which an OFDM signal and a direct sequence spectrum spread signal (DSSSS) having a very large spreading factor synchronized with the corresponding OFDM signal are coupled with each other and then a coupled signal of the two signals is transmitted.

The present invention has also been made in an effort to provide a wireless communication system for synchronization and a method for controlling the same in which the frame and symbol synchronization is acquired based on the coupled signal of the direct sequence spectrum spread signal and the OFDM signal, and then the received OFDM signal is demodulated based on the acquired frame and symbol synchronization.

The present invention has also been made in an effort to provide a wireless communication system for acquiring synchronization and a method for controlling the same that use a sequence spectrum spread signal having a different PN sequence in a base station of each cell, during a handover between cells in a mobile communication system.

An exemplary embodiment of the present invention provides a transmitter installed in a base station included in a wireless communication system for acquiring synchronization, the transmitter including: an IFFT unit configured to perform IFFT with respect to a QAM signal into which a pilot signal is inserted to generate an OFDM signal; a direct sequence spectrum spread signal generator configured to phase shift keying (PSK)-modulate a unique pseudonoise (PN) sequence specifying the base station to generate a direct sequence spectrum spread signal synchronized with the OFDM signal; and an RF transmitter configured to couple the generated OFDM signal and the direct sequence spectrum spread signal synchronized with the OFDM signal, transform the coupled signal into an RF signal, and transmit the signal transformed into the RF signal through an antenna.

The IFFT unit may further insert a cyclic prefix (CP) into the generated OFDM signal.

When the transmission data has a superframe structure, the direct sequence spectrum spread signal generator may generate each direct sequence spectrum spread signal synchronized with the OFDM signal by using a different PN sequence for each frame included in the superframe.

The direct sequence spectrum spread signal generator may generate a direct sequence spectrum spread signal having a different PN sequence in a base station of each cell, during a handover between a plurality of cells included in the wireless communication system.

The transmitter may further include: a signal mapping unit configured to map transmission data to the QAM signal; and a pilot inserting unit configured to insert the pilot signal for channel estimation at a predetermined location of the mapped signal.

Another exemplary embodiment of the present invention provides a receiver included in a wireless communication system for acquiring synchronization, the receiver including: an RF receiver configured to receive a coupled RF signal of an OFDM signal and a direct sequence spectrum spread signal which are transmitted from a transmitter included in the wireless communication system and transform the received RF signal into a baseband signal; a synchronization acquiring unit configured to acquire synchronization based on the direct sequence spectrum spread signal included in the signal transformed into the baseband signal; an FFT unit configured to FFT-transform the OFDM signal included in the signal transformed into the baseband signal based on the acquired synchronization; a channel correcting unit configured to extract a pilot signal from the FFT-transformed FFT signal, estimate a wireless channel based on the extracted pilot signal, and correct the FFT-transformed FFT signal based on the estimated channel factor value; and a signal demapping unit configured to transform the corrected FFT signal into information data.

When the received RF signal has a superframe structure, the synchronization acquiring unit may verify a different PN sequence based on the direct sequence spectrum spread signal, and detect a frame sequence in the superframe based on the verified different PN sequence.

The synchronization acquiring unit may verify a base station transmitting the RF signal based on a predetermined PN sequence for each base station and a PN sequence corresponding to the direct sequence spectrum spread signal, during a handover between a plurality of cells included in the wireless communication system.

Yet another exemplary embodiment of the present invention provides a method for controlling a transmitter installed in a base station included in a wireless communication system for acquiring synchronization, the method including: mapping transmission data to a QAM signal, by a signal mapping unit; inserting a pilot signal for channel estimation in the mapped signal into a predetermined position, by a pilot inserting unit; generating an OFDM signal by performing IFFT for the signal into which the pilot signal is inserted, by an IFFT unit; generating a direct sequence spectrum spread signal synchronized with the OFDM signal by PSK-modulating a unique pseudonoise (PN) sequence specifying the base station, by a direct sequence spectrum spread signal generator; coupling the generated OFDM signal and the direct sequence spectrum spread signal synchronized with the OFDM signal, by an RF transmitter; and transforming the coupled signal into an RF signal and transmitting the signal transformed into the RF signal through an antenna, by the RF transmitter.

In the generating of the direct sequence spectrum spread signal synchronized with the OFDM signal, when the transmission data has a superframe structure, each direct sequence spectrum spread signal synchronized with the OFDM signal may be generated by using a different PN sequence for each frame included in the superframe.

Still another exemplary embodiment of the present invention provides a method for controlling a receiver included in a wireless communication system for acquiring synchronization, the method including: receiving a coupled RF signal of an OFDM signal and a direct sequence spectrum spread signal which are transmitted from a transmitter included in the wireless communication system, by an RF receiver; transforming the received RF signal into a baseband signal, by the RF receiver; acquiring synchronization based on the direct sequence spectrum spread signal included in the signal transformed into the baseband signal, by a synchronization acquiring unit; FFT-transforming the OFDM signal included in the signal transformed into the baseband signal based on the acquired synchronization, by an FFT unit; correcting the FFT-transformed FFT signal by estimating a wireless channel based on a pilot signal, by a channel correcting unit; and transforming the corrected FFT signal into information data, by a signal demapping unit.

The correcting of the FFT-transformed FFT signal may include: extracting the pilot signal from the FFT-transformed FFT signal, by the channel correcting unit; estimating the wireless channel based on the extracted pilot signal, by the channel correcting unit; and correcting the FFT-transformed FFT signal based on the estimated channel factor value, by the channel correcting unit.

In the wireless communication system for acquiring synchronization and the method for controlling the same according to the exemplary embodiment of the present invention, an OFDM signal and a direct sequence spectrum spread signal having a very large spreading factor synchronized with the corresponding OFDM signal are coupled with each other and then the coupled signal of the two signals is transmitted, and as a result, it is possible to acquire frame and symbol synchronization without a preamble signal and improve frequency efficiency.

In the wireless communication system for acquiring synchronization and the method for controlling the same according to the exemplary embodiment of the present invention, the frame and symbol synchronization is acquired based on the coupled signal of the direct sequence spectrum spread signal and the OFDM signal and then the received OFDM signal is demodulated based on the acquired frame and symbol synchronization, and as a result, it is possible to improve efficiency of the entire system.

In the wireless communication system for acquiring synchronization and the method for controlling the same according to the exemplary embodiment of the present invention, a sequence spectrum spread signal having a different PN sequence in a base station of each cell is used during a handover between cells in a mobile communication system, and as a result, it is possible to improve frequency efficiency and system efficiency by performing handover.

### BRIEF DESCRIPTION OF THE DRAWINGS

FIG. 1 is a configuration diagram of a wireless communication system for acquiring synchronization according to an exemplary embodiment of the present invention.

FIG. 2 is a configuration diagram of a transmitter according to the exemplary embodiment of the present invention.

FIG. 3 is a diagram describing a principle for acquiring frame and symbol synchronization according to the exemplary embodiment of the present invention.

FIG. 4 is a configuration diagram of a receiver according to the exemplary embodiment of the present invention.

FIGS. 5 and 6 are diagrams illustrating a frame structure of transmission data in an OFDM type wireless communication system according to another exemplary embodiment of the present invention.

FIG. 7 is a flowchart illustrating a method for controlling a wireless communication system for acquiring synchronization according to a first exemplary embodiment of the present invention.

FIG. 8 is a flowchart illustrating a method for controlling a wireless communication system for acquiring synchronization according to a second exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is noted that technical terms used in the specification are used to just describe a specific exemplary embodiment and do not intend to limit the present invention. Further, if not particularly defined as different meanings, the technical terms used in the present invention should be interpreted as meanings generally appreciated by those with ordinary skill in the art to which the present invention pertains, and should not be interpreted as excessively comprehensive meanings or excessively restricted meanings. Further, when the technical term used in the present invention is a wrong technical term that does not accurately express the spirit of the present invention, the technical term should be substituted and understood by and appreciated as a technical term which can be correctly appreciated by those skilled in the art. In addition, a general term used in the present invention should be interpreted as defined in a dictionary or according to the context and should not be interpreted as an excessively restricted meaning.

If a singular expression used in the present invention is not apparently differently meanton a context, the singular expression includes a plural expression. Further, in the present invention, it should not interpreted that a term such as “comprising” or “including” particularly includes all of various components or various steps disclosed in the invention and it should be analyzed that some components or some steps among them may not be included or additional components or steps may be further included.

Terms including ordinal numbers, such as ‘first’ and ‘second’, which are used in the present invention, can be used to describe various components, but the components should not be limited by the terms. The above terms are used only for distinguishing one component from another component. For example, a first component may be named a second component and similarly, the second component may be named the first component, without departing from the scope of the present invention.

Hereinafter, exemplary embodiments of the present invention will be described in detail with reference to the accompanying drawings, and the like reference numerals refer to like or similar elements regardless of reference numerals and a duplicated description thereof will be omitted.

In describing the present invention, when it is determined that the detailed description of the publicly known art related to the present invention may obscure the gist of the present invention, the detailed description thereof will be omitted. Further, it is noted that the accompanying drawings are used just for easily appreciating the spirit of the present invention and it should not be understood that the spirit of the present invention is limited by the accompanying drawings.

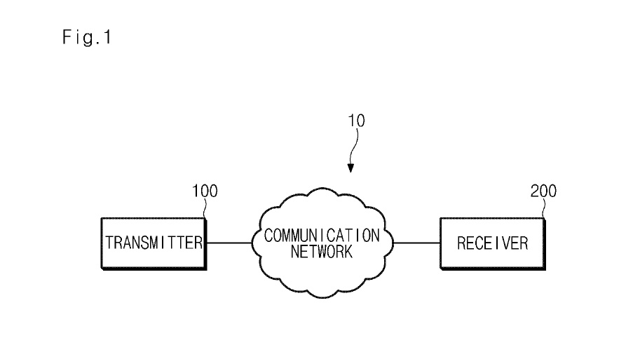

FIG. 1 is a configuration diagram of a wireless communication system 10 for acquiring synchronization according to an exemplary embodiment of the present invention.

As illustrated in FIG. 1, the wireless communication system 10 is configured by a transmitter 100 and a receiver 200. All constituent elements of the wireless communication system 10 illustrated in FIG. 1 are not essential constituent elements, but the wireless communication system 10 may be implemented by more constituent elements or less constituent elements than the constituent elements illustrated in FIG. 1. Herein, the transmitter 100 and the receiver 200 communicate with each other through wire/wireless communication networks.

In the OFDM type wireless communication system 10, in order to acquire frame and symbol synchronization using a direct sequence spectrum spread signal, the transmitter 100 couples the direct sequence spectrum spread signal with an OFDM signal and transforms a coupled signal of the direct sequence spectrum spread signal with an OFDM signal into an RF signal to transmit the transformed RF signal to the receiver 200. Thereafter, the receiver 200 transforms the received signal transformed into the RF signal into a baseband signal and then acquires the frame and symbol synchronization through an inverse spread process which acquires a correlation value of a PN sequence and the received RF signal based on the direct sequence spectrum spread signal included in the signal transformed into the baseband signal, FFT-processes the OFDM signal included in the signal transformed into the baseband signal based on the acquired synchronization, corrects an FFT-processed FFT signal by estimating a wireless channel based on a pilot signal, and then transforms a corrected QAM signal (or the corrected FFT signal) into information data having an originally-transmitted binary data form to acquire the synchronization without a preamble data symbol.

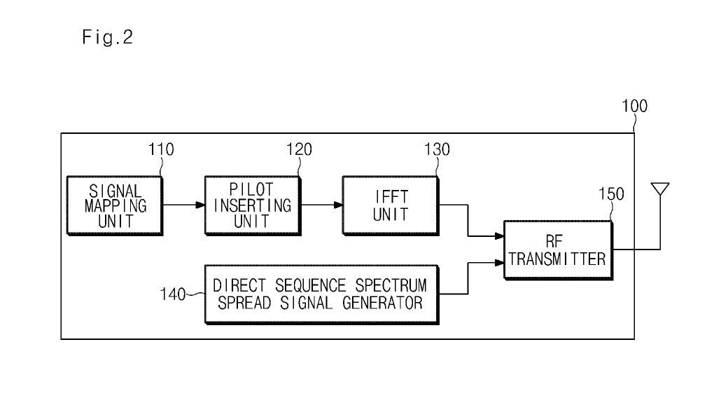

As illustrated in FIG. 2, the transmitter 100 is configured by a signal mapping unit 110, a pilot inserting unit 120, an inverse fast Fourier transform (IFFT) unit 130, a direct sequence spectrum spread signal generator 140, and an RF transmitter 150. All constituent elements of the transmitter 100 illustrated in FIG. 2 are not essential constituent elements, but the transmitter 100 may be implemented by more constituent elements or less constituent elements than the constituent elements illustrated in FIG. 2.

The signal mapping unit 110 maps transmission data (or a transmission data signal) having a binary data form to be transmitted to a quadrature amplitude modulation (QAM) signal. Herein, the QAM type may include quaternary phase shift keying (QPSK), 16-QAM, 64-QAM, and the like.

The pilot inserting unit 120 inserts (or adds) a pilot signal for channel estimation into the signal mapped from the signal mapping unit 110 (or the mapped QAM signal) at a predetermined (or known) location.

The IFFT unit 130 performs inverse fast Fourier transform (IFFT) with respect to the signal into which the pilot signal is inserted from the pilot inserting unit 120 to generate (or acquire/transform) an OFDM signal.

The IFFT unit 130 may insert (or add) a cyclic prefix (CP) into the generated OFDM signal.

The direct sequence spectrum spread signal generator 140 modulates a pseudonoise (PN) sequence by phase shift keying (PSK) to generate the direct sequence spectrum spread signal (or sequence spectrum spread signal: DSS signal or SS signal) synchronized with the OFDM signal.

In this case, in the case where the transmission data to be transmitted has a single frame structure, the direct sequence spectrum spread signal generator 140 PSK-modulates the same (or a different kind of) PN sequence to generate the direct sequence spectrum spread signal (or sequence spectrum spread signal) synchronized with the OFDM signal.

In the case where the transmission data to be transmitted has a superframe structure, the direct sequence spectrum spread signal generator 140 generates the direct sequence spectrum spread signal (or sequence spectrum spread signal) synchronized with the OFDM signal by using a different PN sequence for each frame included in the superframe.

As such, by using the different PN sequence in the superframe structure, the receiver 200 may detect a frame sequence in the superframe.

In a base station of each cell where the transmitter 100 is positioned, a handover function is performed between other base stations by using direct sequence spectrum spread signals having a unique PN sequence different from other base stations, during a handover between the cells.

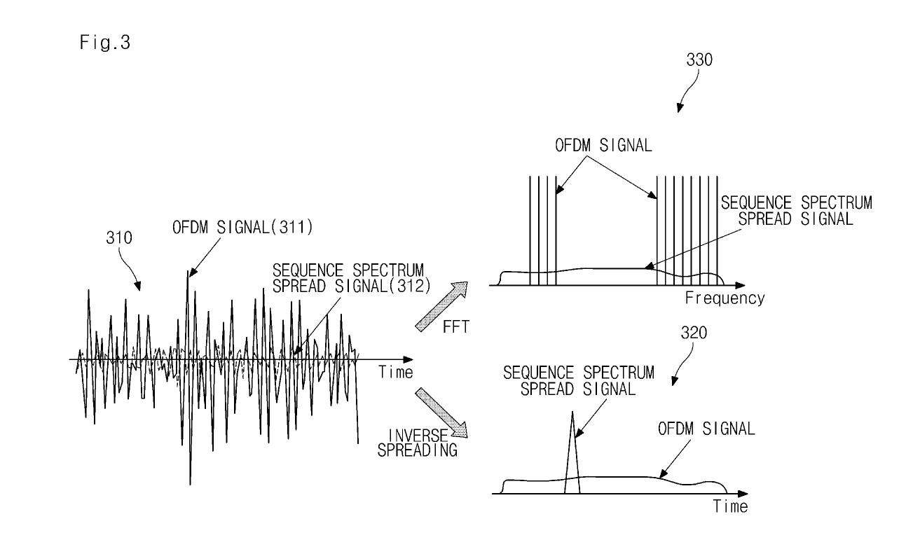

As illustrated in FIG. 3, the RF transmitter 150 couples (310) an OFDM signal 311 generated from the IFFT unit 130 and a direct sequence spectrum spread signal 312 generated from the direct sequence spectrum spread signal generator 140.

The RF transmitter 150 transforms the two coupled signals (for example, the coupled signal of the OFDM signal and the direct sequence spectrum spread signal) into a radio frequency (RF) signal.

The RF transmitter 150 transmits the signal transformed into the RF signal through an antenna (not illustrated) provided in the transmitter 100.

As such, the transmitter 100 couples the direct sequence spectrum spread signal with the OFDM signal and converts the two coupled signals into the RF signal to transmit the converted RF signal through the antenna.

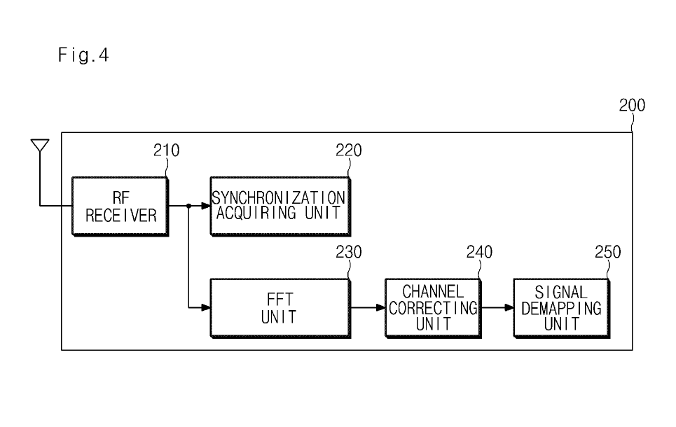

As illustrated in FIG. 4, the receiver 200 is configured by an RF receiver 210, a synchronization acquiring unit 220, an FFT unit 230, a channel correcting unit 240, and a signal demapping unit 250. All constituent elements of the receiver 200 illustrated in FIG. 4 are not essential constituent elements, but the receiver 200 may be implemented by more constituent elements or less constituent elements than the constituent elements illustrated in FIG. 4.

The RF receiver 210 receives the RF signal transmitted from the transmitter 100 through an antenna (not illustrated) provided in the receiver 200. Here, the RF signal may be a coupled signal of the direct sequence spectrum spread signal with the OFDM signal.

The RF receiver 210 transforms the received RF signal into a baseband signal (or baseband data).

As illustrated in FIG. 3, the synchronization acquiring unit 220 acquires (or calculates) (320) frame and time (or symbol) synchronization through an inverse spread process which acquires a correlation value of the a delayed PN sequence and the received RF signal based on the direct sequence spectrum spread signal included in the received RF signal (or included in the RF signal transformed into the baseband signal) (320).

As such, the synchronization acquiring unit 220 performs inverse spread for the RF signal in which the received OFDM signal and the direct sequence spectrum spread signal synchronized with the corresponding OFDM signal are coupled with each other to perform synchronization having a maximum value at a delayed time and having a much larger correlation value than the OFDM signal due to a very large spread factor of the direct sequence spectrum spread signal.

In the case where the received RF signal has a superframe structure, the synchronization acquiring unit 220 verifies different PN sequences based on the direct sequence spectrum spread signal, and detects a frame sequence in the superframe based on the verified different PN sequences.

During the handover between the cells, by using the direct sequence spectrum spread signal having the different PN sequence (or unique PN sequence for each base station) in a base station of each cell, the synchronization acquiring unit 220 (or the receiver 200) may verify the corresponding base station based on the verified PN sequence.

The FFT unit 230 FFT-processes (or transforms) the OFDM signal included in the received RF signal (or the OFDM signal included in the signal transformed into the baseband signal) based on the synchronization acquired through the synchronization acquiring unit 220 (for example, frame and time synchronization).

The FFT unit 230 may remove the CP included in the OFDM signal of the received RF signal and then FFT-process the OFDM signal from which the CP is removed.

As illustrated in FIG. 3, when the FFT unit 230 FFT-transforms the received RF signal at the synchronization (or the synchronizing time) acquired through the synchronization acquiring unit 220, since the direct sequence spectrum spread signal has a very small value in all of the frequency bands, only the OFDM signal (or the OFDM data) may be detected from only the transmitted RF signal (or a subcarrier) (330).

The channel correcting unit 240 extracts the pilot signal from the FFT-processed FFT signal.

The channel correcting unit 240 estimates a wireless channel based on the pilot signal.

The channel correcting unit 240 corrects the FFT-processed FFT signal (or the FFT-processed/transformed QAM signal) based on an estimated channel factor value.

The signal demapping unit 250 transforms (or demaps) the corrected QAM signal (or the corrected FFT signal) into information data having an originally transmitted binary data form.

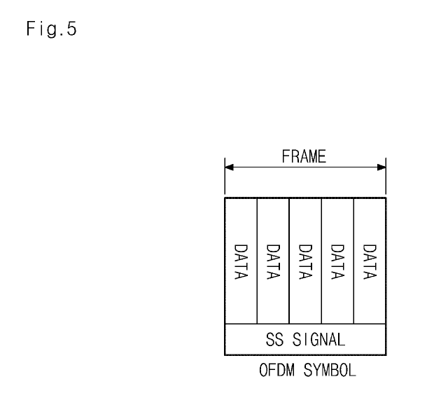

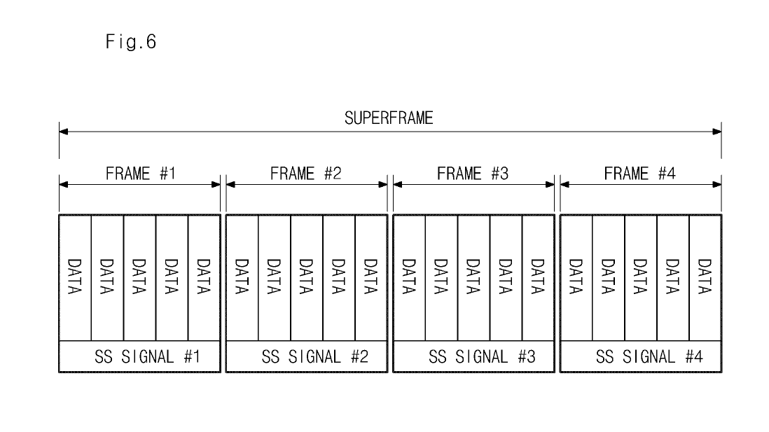

FIGS. 5 and 6 are diagrams illustrating a frame structure of transmission data in an OFDM type wireless communication system 10 according to another exemplary embodiment of the present invention.

FIG. 5 illustrates a single frame structure, and FIG. 6 illustrates a superframe structure configured by four frames.

When one OFDM symbol has 2048 FFT samples and 256 CP samples, a spread factor (SF) of both the single frame structure and the superframe structure becomes 11,520(=(2048+256)*5). As compared with an existing CDMA communication in which a spread factor is 512, it can be seen that the spread factor may be configured to be very large.

Accordingly, the sequence spectrum spread signal (or the direct sequence spectrum spread signal) for synchronization according to the present invention uses a very small signal as compared with the OFDM signal, and barely influences performance for detecting the OFDM signal.

The superframe structure according to the present invention may detect the frame sequence in the superframe by using the sequence spectrum spread signal having a different PN sequence for each frame.

An OFDM type communication system 10 according to the present invention may perform a handover function by using a the sequence spectrum spread signal having a different PN sequence in a base station of each cell, during a handover between cells.

As such, after the OFDM signal and the direct sequence spectrum spread signal having a very large spread factor synchronized with the corresponding OFDM signal are coupled with each other, the coupled signal of the two signals is transmitted to acquire the frame and symbol synchronization without a preamble signal.

As such, after the frame and symbol synchronization is acquired based on the coupled signal of the direct sequence spectrum spread signal and the OFDM signal, the received OFDM signal may be demodulated based on the acquired frame and symbol synchronization.

As such, during the handover between the cells in the mobile communication system, the sequence spectrum spread signal having the different PN sequence in the base station of each cell may be used.

Hereinafter, a method for controlling a wireless communication system for acquiring synchronization according to the present invention will be described in detail with reference to FIGS. 1 to 8.

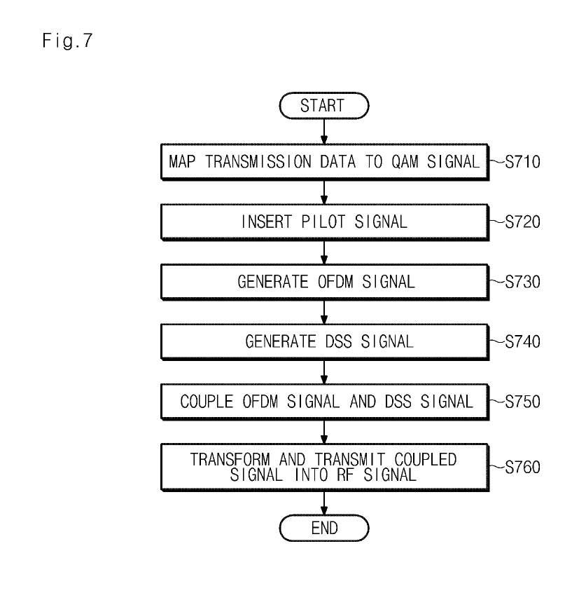

FIG. 7 is a flowchart illustrating a method for controlling a wireless communication system for acquiring synchronization according to a first exemplary embodiment of the present invention.

First, the signal mapping unit 110 maps transmission data (or a transmission data signal) to be transmitted to a QAM signal. Herein, the QAM type may include quaternary phase shift keying (QPSK), 16-QAM, 64-QAM, and the like (S710).

Thereafter, the pilot inserting unit 120 inserts (or adds) the pilot signal for estimating a channel into the mapped signal (or the mapped QAM signal).

For example, the pilot inserting unit 120 inserts the pilot signal into a predetermined known location in the receiver 200 among the mapped signals (S720).

Thereafter, the IFFT unit 130 performs the IFFT with respect to the signal into which the pilot signal is inserted to generate (or acquire/transform) the OFDM signal. In this case, the IFFT unit 130 may insert (or add) the CP into the generated OFDM signal.

As one example, the IFFT unit 130 performs the IFFT for the mapped signal into which the pilot signal is inserted, in order to transform the mapped signal in a frequency area into which the pilot signal is inserted into the OFDM signal in a time area.

As another example, the IFFT unit 130 performs the IFFT for the signal into which the pilot signal is inserted to generate the OFDM signal, and inserts the CP into the generated OFDM signal (S730).

Thereafter, the direct sequence spectrum spread signal generator 140 PSK-modulates the PN sequence to generate the direct sequence spectrum spread signal (or the sequence spectrum spread signal). In this case, in the case where the transmission data has a superframe structure, the direct sequence spectrum spread signal generator 140 generates the direct sequence spectrum spread signal (DSS signal) synchronized with the OFDM signal by using a different PN sequence for each frame. As such, by using the different PN sequence for each frame, the direct sequence spectrum spread signal generator 140 may detect (or verify) the frame sequence in the superframe.

During the handover between the cells, the direct sequence spectrum spread signal generator 140 is configured to generate the direct sequence spectrum spread signal having a different unique PN sequence from other base stations in a base station of each cell to perform the handover function.

That is, a direct sequence spectrum spread signal having a unique PN sequence may be generated for each base station where the corresponding transmitter 100 is formed.

As an example, the direct sequence spectrum spread signal generator 140 PSK-modulates the PN sequence to generate the direct sequence spectrum spread signal synchronized with the OFDM signal (S740).

Thereafter, the RF transmitter 150 couples the OFDM signal generated from the IFFT unit 130 and a direct sequence spectrum spread signal generated from the direct sequence spectrum spread signal generator 140.

As an example, as illustrated in FIG. 3, the RF transmitter 150 couples the OFDM signal 311 and the direct sequence spectrum spread signal 312 (S750).

Thereafter, the RF transmitter 150 transforms the both coupled signals (for example, the coupled signal of the OFDM signal and the direct sequence spectrum spread signal) into the RF signal.

The RF transmitter 150 transmits (or transfers) the signal transformed into the RF signal through an antenna (not illustrated).

As an example, the RF transmitter 150 transforms the coupled signal of the OFDM signal and the direct sequence spectrum spread signal illustrated in FIG. 3 to the RF signal and then transmits the signal transformed into the RF signal to the receiver 200 (S760).

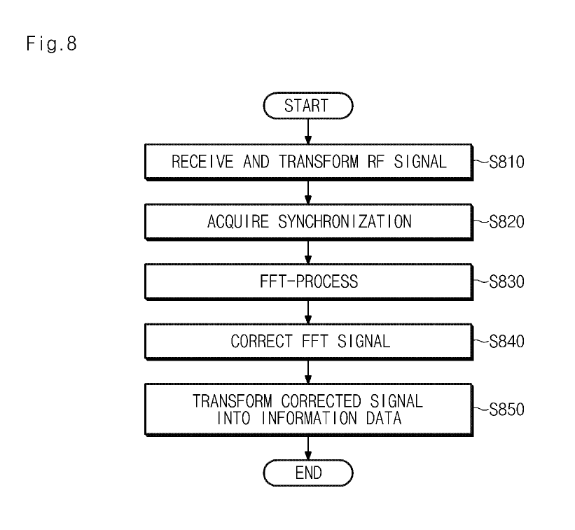

FIG. 8 is a flowchart illustrating a method for controlling a wireless communication system for performing synchronization according to a second exemplary embodiment of the present invention.

First, the RF receiver 210 receives the RF signal transmitted from the transmitter 100 through an antenna (not illustrated). Here, the RF signal may be a coupled signal of the direct sequence spectrum spread signal with the OFDM signal.

The RF receiver 210 transforms the received RF signal into a baseband signal (or baseband data) (S810).

Thereafter, the synchronization acquiring unit 220 acquires (or calculates) frame and time (or symbol) synchronization through an inverse spread process which acquires a correlation value of the delayed PN sequence and the received RF signal based on the direct sequence spectrum spread signal included in the received RF signal (or included in the RF signal transformed into the baseband signal).

Here, in the case where the received RF signal has a superframe structure, the synchronization acquiring unit 220 may verify a different PN sequence for each frame based on the direct sequence spectrum spread signal included in the received RF signal (or included in the RF signal transformed into the baseband signal), and detect (or verify) a frame sequence in the superframe based on the verified different PN sequence.

The synchronization acquiring unit 220 generates the direct sequence spectrum spread signal by using the unique PN sequence for each base station to verify the base station transmitting the RF signal based on the verified PN sequence (S820).

Thereafter, the FFT unit 230 FFT-processes (or transforms) the OFDM signal included in the received RF signal based on the synchronization (for example, frame and time synchronization) acquired through the synchronization acquiring unit 220. In this case, the FFT unit 230 may remove the CP included in the OFDM signal of the received RF signal and then FFT-process the OFDM signal from which the CP is removed.

As an example, the FFT unit 230 transforms the OFDM signal in the time area included in the received RF signal into the OFDM signal in the frequency area based on the synchronization acquired through the synchronization acquiring unit 220 (S830).

Thereafter, the channel correcting unit 240 estimates a wireless channel based on the pilot signal to correct the FFT-processed FFT signal (or the FFT-processed QAM signal). Herein, the channel correcting unit 240 may extract the pilot signal from the FFT-processed FFT signal.

As an example, the channel correcting unit 240 extracts the pilot signal from the FFT-processed FFT signal, estimates a channel factor value based on the extracted pilot signal, and corrects the FFT-processed FFT signal (or the FFT-processed/transformed QAM signal) based on the estimated channel factor value to compensate for abnormal distortion generated by adjacent channel interference, multi-path fading, or the like (S840).

Thereafter, the signal demapping unit 250 transforms (or demaps) the corrected QAM signal (or the corrected FFT signal) into information data having an originally transmitted binary data form (S850).

In the exemplary embodiment of the present invention, as described above, after the OFDM signal and the direct sequence spectrum spread signal having a very large spread factor synchronized with the corresponding OFDM signal are coupled with each other, the coupled signal of the two signals is transmitted, thereby acquiring the frame and symbol synchronization without a preamble signal and improving frequency efficiency.

In the exemplary embodiment of the present invention, as described above, after the frame and symbol synchronization is acquired based on the coupled signal of the direct sequence spectrum spread signal and the OFDM signal, the received OFDM signal may be demodulated based on the acquired frame and symbol synchronization, thereby improving efficiency of the entire system.

In the exemplary embodiment of the present invention, as described above, during the handover between the cells in the mobile communication system, it is possible to improve frequency efficiency and system efficiency according to the handover performance, by using the sequence spectrum spread signal having a different PN sequence in a base station of each cell.

Various modifications and changes can be made by those skilled in the art without departing from the essential characteristic of the present invention. Accordingly, the various exemplary embodiments disclosed herein are intended not to limit but to describe the technical spirit of the present invention and the true scope of the spirit of the present invention is not limited to the exemplary embodiments. The scope of the present invention should be interpreted by the appended claims and the technical spirits in the equivalent range theretoare analyzed to be embraced by the scope of the present invention.

What is claimed is:

1. A transmitter installed in a base station included in a wireless communication system for acquiring synchronization, the transmitter comprising:
an IFFT unit configured to perform IFFT with respect to a QAM signal into which a pilot signal is inserted to generate an OFDM signal;
a direct sequence spectrum spread signal generator configured to phase shift keying (PSK)-modulate a unique pseudonoise (PN) sequence specifying the base station to generate a direct sequence spectrum spread signal synchronized with the OFDM signal; and
an RF transmitter configured to couple the generated OFDM signal and the direct sequence spectrum spread signal synchronized with the OFDM signal, transform the coupled signal into an RF signal, and transmit the signal transformed into the RF signal through an antenna.

2. The transmitter of claim 1, wherein the IFFT unit further inserts a cyclic prefix (CP) into the generated OFDM signal.

3. The transmitter of claim 1, wherein when the transmission data has a superframe structure, the direct sequence spectrum spread signal generator separately generates a direct sequence spectrum spread signal synchronized with the OFDM signal by using a different PN sequence for each frame included in the superframe.

4. The transmitter of claim 1, wherein the direct sequence spectrum spread signal generator generates a direct sequence spectrum spread signal having a different PN sequence in a base station of each cell, during a handover between a plurality of cells included in the wireless communication system.

5. The transmitter of claim 1, further comprising:
a signal mapping unit configured to map transmission data to the QAM signal; and
a pilot inserting unit configured to insert the pilot signal for channel estimation at a predetermined location of the mapped signal.

6. A receiver included in a wireless communication system for acquiring synchronization, the receiver comprising:
an RF receiver configured to receive a coupled RF signal of an OFDM signal and a direct sequence spectrum spread signal which are transmitted from a transmitter included in the wireless communication system and transform the received RF signal into a baseband signal;
a synchronization acquiring unit configured to acquire synchronization based on the direct sequence spectrum spread signal included in the signal transformed into the baseband signal;
an FFT unit configured to FFT-transform the OFDM signal included in the signal transformed into the baseband signal based on the acquired synchronization;
a channel correcting unit configured to extract a pilot signal from the FFT-transformed FFT signal, estimate a wireless channel based on the extracted pilot signal, and correct the FFT-transformed FFT signal based on the estimated channel factor value; and
a signal demapping unit configured to transform the corrected FFT signal into information data.

7. The receiver of claim 6, wherein when the received RF signal has a superframe structure, the synchronization acquiring unit verifies a different PN sequence based on the direct sequence spectrum spread signal, and detects a frame sequence in the superframe based on the verified different PN sequence.

8. The receiver of claim 6, wherein the synchronization acquiring unit verifies a base station transmitting the RF signal based on a predetermined PN sequence for each base station and a PN sequence corresponding to the direct sequence spectrum spread signal, during a handover between a plurality of cells included in the wireless communication system.

9. A method for controlling a transmitter installed in a base station included in a wireless communication system for acquiring synchronization, the method comprising:
mapping transmission data to a QAM signal, by a signal mapping unit;
inserting a pilot signal for channel estimation in the mapped signal into a predetermined position, by a pilot inserting unit;
generating an OFDM signal by performing IFFT for the signal into which the pilot signal is inserted, by an IFFT unit;
generating a direct sequence spectrum spread signal synchronized with the OFDM signal by PSK-modulating a unique pseudonoise (PN) sequence specifying the base station, by a direct sequence spectrum spread signal generator;
coupling the generated OFDM signal and the direct sequence spectrum spread signal synchronized with the OFDM signal, by an RF transmitter; and
transforming the coupled signal into an RF signal and transmitting the signal transformed into the RF signal through an antenna, by the RF transmitter.

10. The method of claim 9, wherein in the generating of the direct sequence spectrum spread signal synchronized with the OFDM signal,
when the transmission data has a superframe structure, each direct sequence spectrum spread signal synchronized with the OFDM signal is generated by using a different PN sequence for each frame included in the superframe.

11. A method for controlling a receiver included in a wireless communication system for acquiring synchronization, the method comprising:
receiving a coupled RF signal of an OFDM signal and a direct sequence spectrum spread signal which are transmitted from a transmitter included in the wireless communication system, by an RF receiver;
transforming the received RF signal into a baseband signal, by the RF receiver;
acquiring synchronization based on the direct sequence spectrum spread signal included in the signal transformed into the baseband signal, by a synchronization acquiring unit;
FFT-transforming the OFDM signal included in the signal transformed into the baseband signal based on the acquired synchronization, by an FFT unit;
correcting the FFT-transformed FFT signal by estimating a wireless channel based on a pilot signal, by a channel correcting unit; and
transforming the corrected FFT signal into information data, by a signal demapping unit.

12. The method of claim 11, wherein the correcting of the FFT-transformed FFT signal includes:
extracting the pilot signal from the FFT-transformed FFT signal, by the channel correcting unit;
estimating the wireless channel based on the extracted pilot signal, by the channel correcting unit; and
correcting the FFT-transformed FFT signal based on the estimated channel factor value, by the channel correcting unit.
